(19) United States
(12) Patent Application Publication
(10) Pub. No.: US 2001/0025628 A1
(43) Pub. Date: Oct. 4, 2001

(54) Fuel supply device and internal combustion engine mounting the same

(76) Inventors: Kiyoshi Amou, Chiyoda (JP); Yoshio Okamoto, Minori (JP); Takehiko Kowatari, Kashiwa (JP); Ayumu Miyajima, Narita (JP); Yuzo Kadomukai, Ishioka (JP); Toru Ishikawa, Kitaibaraki (JP); Masami Nagano, Hitachinaka (JP); Takanobu Ichihara, Hitachinaka (JP); Hiroaki Saeki, Hitachinaka (JP); Kenji Watanabe, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/819,639

(22) Filed: Mar. 29, 2001

(30) Foreign Application Priority Data
Mar. 29, 2000 (JP) 2000-95224

(51) Int. Cl. F02M 51/00; F02M 23/00

(52) U.S. Cl. 123/491; 123/531

(57) ABSTRACT

Atomizing air flowing in an atomizing gas passage is merged with fuel spray to promote atomization of the fuel, and carrier air flowing in a carrier gas passage is merged with the fuel spray at a further downstream position so as to surround around the fuel spray. By doing so, the atomized fuel spray is carried to the downstream side so as to prevent the fuel spray from adhering onto the wall surface. Starting-up performance, fuel consumption and exhaust gas cleaning of an internal combustion engine are improved.

### BACKGROUND OF THE INVENTION

1. Technical Field

The present invention relates to a fuel supply device for an internal combustion engine of a vehicle such as an automobile and an internal combustion engine mounting a fuel supply device, and particularly to a technology suitable for improving start-up performance of an internal combustion engine and for reducing an amount of harmful substances, particularly, HC emitted from an internal combustion engine.

As a means for improving a start-up performance and improving a fuel consumption and for reducing harmful substances, particularly, HC of the internal combustion engine, it is effective to atomize fuel spray injected from a fuel injector and to reduce an amount of fuel adhering on an inner surface of the intake pipe. Further, stability of combustion can be attained by atomizing the fuel spray.

2. Prior Art

It is known that an auxiliary fuel injector used at starting operation of an internal combustion engine is provided in order to supply highly an atomized fuel spray to the internal combustion engine. A cold-start fuel control system comprising a cold-start fuel injector, a heater and an idle speed control valve (hereinafter, referred to as ISC valve) is disclosed in the specification and drawings of U.S. Pat. No. 5,482,023.

In this system, a part of air from the ISC valve (a first air flow) is merged with a fuel injected from the cold-start fuel injector. Therefore, an opening of an air flow passage from the ISC valve is arranged in an annular shape so as to surrounding an outlet portion of the cold-start fuel injector. The fuel from the cold-start fuel injector with the first air flow just after merging enter into an inside of a cylindrical heater arranged in a row downstream of the cold-start fuel injector.

On the other hand, an air passage for allowing part of air from the ISC valve to flow therethrough is formed in an outer periphery of the heater, and the air flowing through this air passage (a second air flow) merges with the fuel spray passed through the inside of the heater at the outlet portion of the heater. The fuel coming out from the cold-start fuel injector is promoted to be vaporized while passing through the inside of the heater, and is further promoted to be vaporized by being mixed with the second air flow at the outlet portion of the heater.

In the conventional system, a mixing chamber for mixing the fuel and the air inside the cylindrical heater is formed to form a kind of atomizer having a heater outlet as the outlet by arranging from the upstream side in order of the cold-start fuel injector, the merging point of the fuel injected from the cold-start fuel injector with the air flow and the mixing chamber constructed inside the heater in a row. It can be considered that the atomizer is an air assist type atomizer which uses an energy of the air flow, and is also an internal mixing type atomizer which performs air-liquid mixing by merging the fuel with the air inside the atomizer.

In the system, the fuel spray is always in contact with the inner wall surface of the mixing chamber, that is, the inner wall surface of the heater while the fuel is being injected. Therefore, the heater load of atomizing the fuel spray becomes large and the consumed electric power also becomes large.

### SUMMARY OF THE INVENTION

An object of the present invention is to provide a fuel supply device and an internal combustion engine mounting a fuel supply device wherein to reduce an electric energy consumed in a heater in order to promote an atomization of a fuel spray injected from a liquid fuel injector, or to eliminate the heater in some cases.

Another object of the present invention is to provide a fuel supply device and an internal combustion engine mounting a fuel supply device wherein to improve a reliability and s durability of a heater by reducing an electric energy consumed by the heater.

According to the present invention, a fuel supply device comprises a fuel atomizing device for atomizing fuel spray injected from a liquid fuel injector by an action of gas, the atomized fuel spray being supplied in a downstream of a throttle valve in an intake pipe having the throttle valve, wherein the fuel supply device comprises a first gas passage for jetting atomizing gas which acts on the fuel spray injected from a liquid fuel injection hole of the fuel injector to promote atomization of the fuel spray, the first gas passage being opened around the liquid fuel injection hole; a second gas passage for generating a mixed gas by jetting a carrying gas to the fuel spray so as to surround around the fuel spray of which atomization is promoted by the atomizing gas; and a heater disposed so as to be positioned in the periphery of a carrying passage of the mixed gas.

By doing so, since the atomizing gas promotes atomization of the fuel spray and the atomization-promoted fuel spray is carried so as to be surrounded by the carrying gas, the burden of the heater is reduced and the amount of fuel adhering on the wall surface is reduced.

### BRIEF DESCRIPTION OF DRAWINGS

FIG. 1 is a schematic block diagram showing a first embodiment of an internal combustion engine mounting a fuel supply device in accordance with the present invention;

FIG. 2 is an enlarged cross-sectional side view showing the fuel supply device shown in FIG. 1;

FIG. 3(b) is a view showing a carrying gas swirling ember in the fuel supply device shown in FIG. 2 seeing from the direction of air flow, and FIG. 3(a) is a cross-sectional view showing the carrying gas swirling member being taken on the plane of the line A-A of FIG. 3(b).

FIG. 4(a) is a view showing an atomizing gas swirling member in the fuel supply device shown in FIG. 2 seeing from the direction of air flow, and

FIG. 4(b) is a cross-sectional view showing the carrying gas swirling member being taken on the plane of the line A-A of FIG. 4(a);

FIG. 5 is a graph showing the relationship between gas-to-liquid liquid flow rate ratio and average droplet size of fuel spray when pressure in the intake pipe is kept constant;

FIG. 6 is a schematic block diagram showing a second embodiment of an internal combustion engine mounting a fuel supply device in accordance with the present invention;

FIG. 7 is a perspective view showing a third embodiment of an internal combustion engine mounting a fuel supply device in accordance with the present invention;

FIG. 8 is a vertical cross-sectional view showing the fuel supply device shown in FIG. 7;

FIG. 9 is a vertical cross-sectional side view showing the atomizer portion of the fuel supply device shown in FIG. 7; and

FIG. 10(a), FIG. 10(b) and FIG. 10(c) are graphs explaining effects of atomization of fuel spray on cleaning of exhaust gas.

### DESCRIPTION OF THE PREFERRED EMBODIMENTS OF THE INVENTION

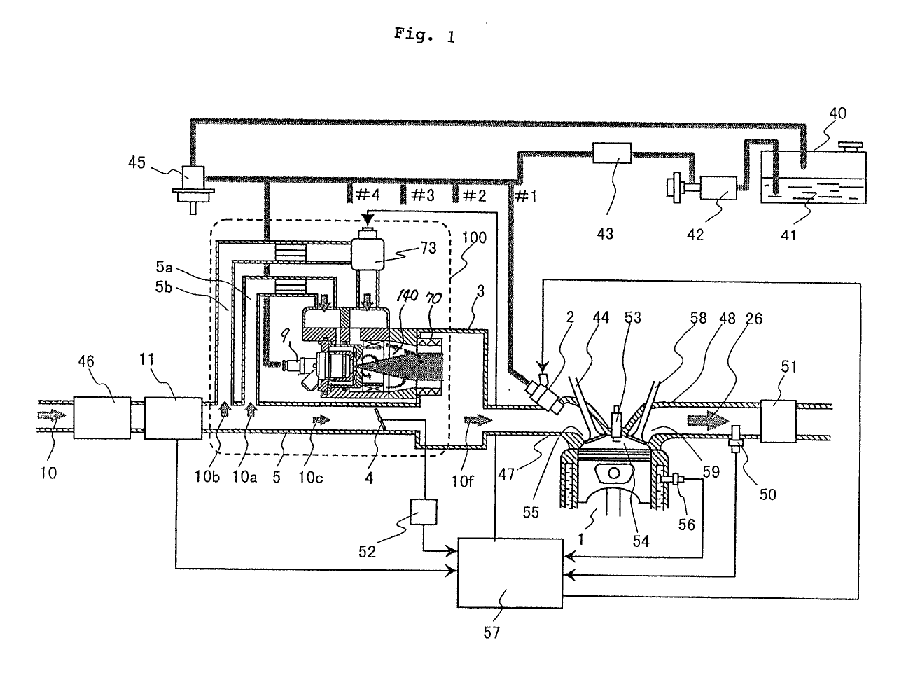

A first embodiment a fuel supply device and an internal combustion engine mounting a fuel supply device according to the present invention will be described below, referring to FIG. 1 to FIG. 4. The first embodiment uses an intake air as an atomizing gas for promoting atomization of the fuel spray and also as a carrier gas for carrying the atomized fuel spray.

FIG. 1 is a schematic block diagram showing the first embodiment of an internal combustion engine mounting a fuel supply device in accordance with the present invention which is of an ignition type internal combustion engine and operated using gasoline as the fuel.

An internal combustion engine 1 comprises a combustion chamber 54 having an ignition plug 53 exposing to the combustion chamber 54; an intake hole 55 for introducing a mixture of air and fuel into the combustion chamber 54; an intake valve 44 for opening and closing the intake hole 55; an exhaust hole 59 for exhausting gas after burned; and an exhaust valve 58 for opening and closing the exhaust hole 59.

The internal combustion engine 1 further comprises a water temperature sensor 56 for detecting temperature of engine cooling water in a side portion of the combustion chamber 54 to detect an operating condition and a rotation sensor (not shown in figure) in a lower portion of the combustion chamber 54, as a result an operation condition of the internal combustion engine 1 can be detected.

An intake system for taking air in the combustion chamber 54 comprises an air cleaner 46; an air flow sensor 11; a throttle valve 4 and a throttle sensor 52 composing an intake control unit; and an intake pipe 5. The intake pipe 5 includes an intake assembling pipe 3 and an intake manifold 47 connected to the intake hole 55. The intake manifold 47 is branched to a plurality of cylinders from the intake assembling pipe 3, but FIG. 1 illustrates only one cylinder portion.

A fuel supply device to the internal combustion engine 1 in this embodiment according to the present invention comprises a first fuel supply device and a second fuel supply device. The first fuel supply device is composed of a first liquid fuel injector 2 which is arranged at a position upstream of each of the intake valves 44 of the cylinders and downstream of the intake assembling pipe 3. The first liquid fuel injector 2 injects fuel toward the upstream side of the intake valve 44 disposed in a wall portion of the intake manifold 47 to open and close the intake hole 55.

The second fuel supply device 100 is arranged in the upstream side of the intake assembling pipe 3 in the intake system. The second fuel supply device 100 comprises a intake pipe 5 containing a throttle valve 4; intake bypass pipes 5a, 5b branched from the intake pipe 5 in the upstream portion of the throttle valve 4; an ISC valve 73 arranged in a middle portion of the intake bypass pipe 5b; and a second liquid fuel injector 9 for injecting fuel to the cylinders in common.

And the atomization of the fuel spray 6 injected from the second liquid fuel injector 9 is promoted by the air passed through the intake bypass pipes 5a, 5b to produce a mixed gas to be supplied to the intake assembling pipe 3. The intake bypass pipes 5a, 5b may be formed in one common pipe in the upstream portion and branched in a middle portion (in the downstream portion). The second fuel supply device 100 mainly functions to supply fuel at warming-up idling operation, and the amount of fuel supply is controlled by the second liquid fuel injector 9, and the amount of intake air is controlled by the ISC valve 73.

The first liquid fuel injector 2 is arranged at the wall portion of the intake manifold 47, and injects fuel in the direction toward the intake valve 44. The second liquid fuel injector 9 is operated for a predetermined time period at warming-up operation of the internal combustion engine 1. Each of the first and the second liquid fuel injectors 2, 9 uses an electromagnetic type fuel injection valve, and controls the amount of injected fuel is controlled by time periods of opening and closing of a valve and a valve sheet inside the fuel injector. The control of the amount of injected fuel is performed by an engine control unit (hereinafter, referred to as ECU) corresponding to operating condition such as an amount of intake air detected from a signal from the sensor.

Further, each of the first and the second liquid fuel injectors 2, 9 is a fuel injection valve of an upstream swirl type, and comprises a member (fuel swirl member) for adding a swirl force to the fuel in the upstream side of the valve sheet, and injects the fuel while adding swirl to the fuel passing through a liquid fuel injection hole arranged in the downstream side of the valve sheet. By doing so, a cone-shaped and superior atomized fuel spray is formed.

The amount of intake air supplied to the internal combustion engine 1 is accurately measured using the air flow sensor 11, the throttle valve 4, the throttle valve sensor 52, the ISC valve 73 and so on. The throttle valve 4 is an intake air control member for varying an amount of air flowing inside the intake pipe 5 by being rotated inside the intake pipe 5 to vary an air flow area projected on the cross section of the intake pipe 5.

The exhaust system comprises an exhaust manifold 48; an oxygen concentration sensor 50 for measuring an oxygen concentration in an exhaust gas; a ternary catalyst converter 51 for exhaust gas cleaning; and a dissipative muffler (not shown in figure) and so on.

The ternary catalyst converter 51 purifies with a highly purification rate NOx, CO HC exhausted from the internal combustion engine 1 operated under a condition near the stoichiometric air-fuel ratio.

In prior to starting up the internal combustion engine 1, the fuel supply system pressurizes the fuel (gasoline) 41 in a fuel tank 40 using a fuel pump 42 to pump the fuel to the first fuel injector 2 and the second fuel injector 9 with a preset pressure through a filter 43. The fuel pressure is regulated by a pressure regulator 45 so that a pressure difference to a pressure of the intake pipe may become constant.

In the construction described above, the mixed gas of the fuel injected from the first and the second liquid fuel injectors 2, 9 and the intake air 10 is sucked into the combustion chamber 54 in the intake stroke, and the sucked mixed gas is compressed in the compression stroke and then ignited by the ignition plug 53 to be burned. The exhaust gas 26 exhausted from the internal combustion engine 1 in the exhaust stroke is discharged to atmosphere out of the exhaust system.

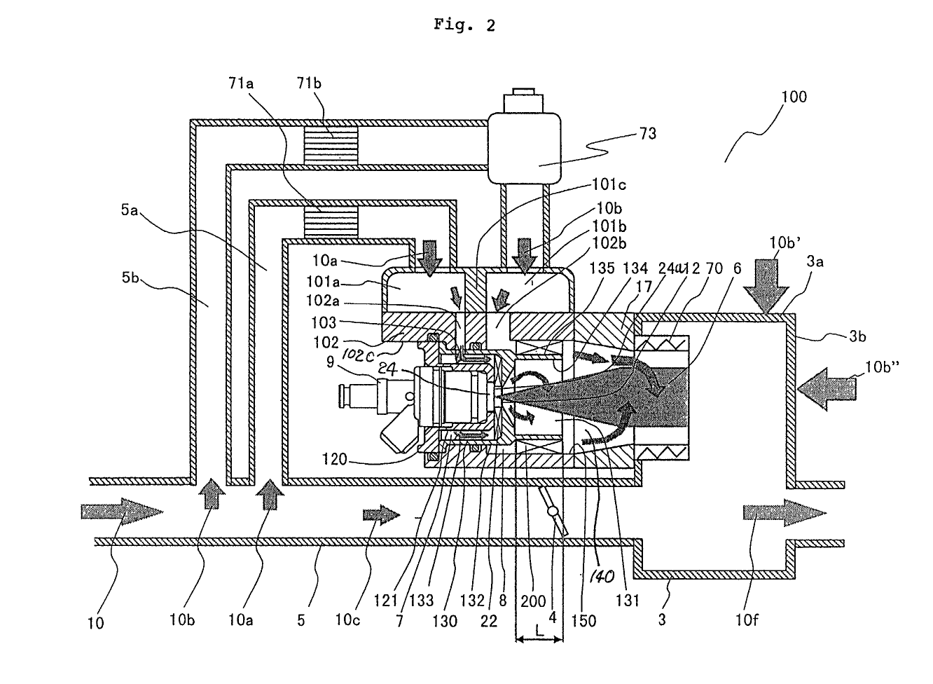

The construction of the second fuel supply device 100 will be described below in detail, referring to FIG. 2. FIG. 2 is an enlarged longitudinal cross-sectional side view showing the fuel supply device 100.

An end of an intake bypass pipe 5a is connected to a pressure regulation chamber 101a to supply the intake air 10a to the pressure regulation chamber 101a as atomizing air. An intake bypass pipe 5b has the ISC valve 73 at a position in the middle of the intake bypass pipe 5b. The position in the middle of the intake bypass pipe 5b may include the inlet portion or the outlet portion, and accordingly, for example, the ISC valve 73 may be arranged between the outlet portion (the end portion in the downstream side) of the intake bypass pipe 5b and the pressure regulation chamber 101b. The end portion of the intake bypass pipe 5b in the downstream side is connected to (communicated with) the pressure regulation chamber 101b to supply the intake air 10b to the pressure regulation chamber 101b as a carrier air. The pressure chambers 101a and 101b are separated from each other by an isolation wall 101c.

An atomizer base member 102 is connected to the downstream portion of the pressure chambers 101a and 101b. In this embodiment according to the present invention, the atomizer base member 102 is formed in a cylindrical shape, and a cylindrical orifice 17 and a heater 70 are connected in the downstream side to form a mixed gas generating chamber 140 inside of the atomizer base member 102.

The atomizer base member 102 comprises an atomizing gas passage 102a and a carrier gas passage 102b, and each of the pressure regulation chambers 101a and 101b is communicated with the atomizing gas passage 102a and the carrier gas passage 102b.

Inside the atomizer base member, the atomizer base member 102 comprises a fuel injector fitting hole 102c communicating with the upstream side of the mixed gas generating chamber 140, and in the fuel injector fitting hole 102c, a gas-liquid mixture injection nozzle 130 and an injector holder 120 and the second liquid fuel injector 9 are concentrically fit so as to positioned in the inside in this order.

The atomizing gas passage 102a is communicated with a nozzle passage 103 arranged in the gas-liquid mixture injection nozzle 130. The nozzle passage 103 is communicated with an atomizing gas passage 7 of an annular gap which is formed by an inner wall surface (an inner peripheral surface) 133 of the gas-liquid mixture injection nozzle 130, an outer wall surface (an outer peripheral surface) 121 of the injector holder 120 and a front end surface 24a of a liquid injecting nozzle 24 of the liquid fuel injector 9.

The front end surface 24a of the liquid injecting nozzle 24 has a liquid fuel injection hole (not shown in figure), and by using the front end surface 24a as a part of the passage wall of the atomizing gas passage 7, the opening of the atomizing gas passage 7 is brought close to the fuel injection hole of the liquid fuel injector 9 so that the intake air 10a for atomization may effectively act onto the beginning end portion of the fuel spray 6 injected from the liquid fuel injector 9.

Further, as to be described later, when a swirl force is imparted to the sprayed fuel inside the liquid fuel injector 9, a radius of the swirl of the fuel spray 6 becomes larger as a distance from the fuel injection hole of the liquid fuel injector 9 is increased. Therefore, since the atomizing gas passage 7 is opened by bring it close to the fuel injection hole along the front end surface 24a of the liquid injection nozzle 24 of the liquid fuel injector 9, the length of the atomizing gas passage 7 in the radial direction can be made linger, and consequently it is advantageous to give a directional property to the atomizing air flow.

Further, since size of the gas-liquid mixture injection hole 12 of the gas-liquid mixture injection nozzle 130 following to the atomizing gas passage 7 can be decreased smaller, the freedom of design to the dimensions of the parts other than the gas-liquid mixture injection hole 12 can be increased by the decreased amount of the size.

The gas-liquid mixture injection hole 12 is bored at a position opposite to the front end surface 24a of the liquid fuel injector 9 in the gas-liquid mixture injection nozzle 130, and the downstream end of the atomizing gas passage 7 is communicated with the inside of the inner wall surface (the inner peripheral surface) of a cylindrical guide 131 extending toward the downstream side from the gas-liquid mixture injection nozzle 130 through the gas-liquid mixture injection hole 12 from the opening.

The gas-liquid mixture injection hole 12 is a thin edge orifice so that the length of the parallel portion of the gas-liquid mixture injection hole 12 to the flow direction of the fuel spray 6 and the atomizing gas 10a flowing in the gas-liquid mixture hole 12 is made as short as possible. Further, the gas-liquid mixture injection hole 12 is formed in the shape that a cross-sectional area of the passage is enlarged toward the downstream side, and connected to the inner wall surface (the inner peripheral surface) 134 of the guide 131 after being enlarged. The guide 131 is formed in the shape that both of the inner peripheral surface 134 and the outer peripheral surface 135 of the guide 131 become parallel to the flow direction in a predetermined length L.

The carrier gas passage 102b is communicated with a carrier gas passage 8 which is an annular gap formed by the inner wall surface (an inner peripheral surface) 150 of the atomizer base member 102, a part of the outer wall surface 132 of the gas-liquid mixture injection nozzle 130 and the outer wall surface 135 of the guide 131.

The atomizing gas passage 102a and the carrier gas passage 102b are merged with each other in the upstream portion of the orifice 17 connected to the downstream portion of the atomizer base member 102 through the annular gaps of the atomizing gas passage 7 and the carrier gas passage 8, respectively. The orifice 17 is formed in a reducing shape that the cross sectional area of the passage is decreased toward the downstream side. In the further downstream side of the orifice 17, the cylindrical heater 70 forming the passage of the fuel spray inside of the cylindrical heater 70 is connected to the orifice 17. The heater 70 is arranged so that the outlet of the heater 70 may be communicated with the inside of the intake assembling pipe 3.

The parts described above basically compose the fuel atomizer which effectively produces and transports (supplies) the mixed gas to the downstream side by atomizing the fuel spray 6 injected from the liquid fuel injector 9 and by mixing gas and liquid using the atomizing air 10a, the carrier air 10b and the heater 70.

Next, a flow of the intake air 10 will be described below.

Referring to FIG. 1 and FIG. 2, as the internal combustion engine 1 is rotated, the inside of the intake pipe 5 including the intake assembling pipe 3 becomes a predetermined negative pressure. The intake air 10 sucked from the outside by the negative pressure inside the intake pipe 5 is filtered by passing through the air cleaner 46, and then the amount of the intake air 10 is measured by the air flow sensor 11, and reaches the upstream side of the throttle valve 4. At starting operation and during idling operation, almost all the intake air 10 flows into the intake bypass pipes 5a, 5b as the atomizing air 10a and the carrier air 10b, respectively, and reaches to the ISC valve 73.

The ISC valve 73 controls the flow rate of the carrier air 10b flowing through the intake bypass pipe 5b. At starting operation and during idling operation of the internal combustion engine 1, the flow rate of the necessary intake air 10 is controlled by the ISC valve 73 because the throttle valve 4 is closed (in fully closed state). Further, the flow rate of the carrier air 10b is very large compared to the flow rate of the atomizing air 10a, and can sufficiently supply the flow rate of the intake air necessary at starting operation and during idling operation. Therefore, by controlling the flow rate of the carrier air 10b without controlling the flow rate of the atomizing air 10a, the idling operation of the internal combustion engine 1 can be performed.

A part of the intake air 10 flows into the combustion chamber 54 as the intake air 10c by leaking through a very small gap between the throttle valve 4 and the intake pipe 5 even when the throttle valve 4 is in the fully closed state. However, the mount of the intake air 10c is negligible small compared to the amount of the atomizing air 10a and the amount of the carrier air 10b.

Although each of the intake bypass pipes 5a and 5b in this embodiment according to the present invention is branched from the intake pipe 5, these passages may be integrated to a single passage, not independently separated. In that case, the isolation wall 101c separating the pressure regulation chambers 101a and 101b is eliminated to form a single pressure regulation chamber. By doing so, the atomizing gas passage 102a and the carrier gas passage 102b are communicated with the same pressure regulation chamber. Further, the ISC valve 73 is disposed at a portion in the middle of the integrated intake bypass pipe. The position in the middle of the intake bypass pipe may include the inlet portion or the outlet portion, and accordingly, for example, the ISC valve 73 may be arranged between the outlet portion (the end portion in the downstream side) of the intake bypass pipe and the pressure regulation chamber.

In this embodiment according to the present invention, the construction of the intake bypass pipes 5a, 5b and the installing position of the ISC valve 73 are determined so that the supplied pressure to the atomizing air 10a at the starting operation and during the idling operation may be maintained at a preset pressure. In the case where the intake bypass pipes 5a, 5b are integrated in the single bypass pipe, there are some cases where the carrier air 10b and the atomizing air 10a are not supplied under a normal condition to the carrier gas passage 8 and the atomizing gas passage 7 by the intake air flow rate control of the ISC valve 73.

However, in this embodiment according to the present invention, the carrier air 10b is flow controlled by the ISC valve 73, but the atomizing air 10a can be supplied under a normal condition because the atomizing air 10a is not controlled. Therefore, the atomizing air 10a effectively acts on the fuel spray to stabilize the promoting of atomization.

Flow of the intake air 10a downstream of the ISC valve 73 will be described below.

The intake air 10b controlled by the ISC valve 73 flows into the pressure regulation chamber 101b having a predtermined space. The intake air 10b entering into the pressure regulation chamber 101b mainly flows into the carrier gas passage 102b as the carrier air 10b having a role of transporting the fuel spray 6 downstream. The splitting (divided) flow ratio between the atomizing air 10a and the carrier air 10b is determined by the ratio of passage cross sectional areas of the gas-liquid mixture injection hole 12 provided in the gas-liquid injection nozzle 130 and the carrier gas passage 102b.

In the case where the intake bypass pipes 5a, 5b are integrated to the single bypass pipe, the intake air controlled by the ISC valve 73 flows into the single pressure regulation chamber having a predetermined space, and is split to the atomizing gas passage 102a and the carrier gas passage 102b as the atomizing air 10a and the carrier air 10b, respectively. Therein, the splitting flow ratio between the atomizing air 10a and the carrier air 10b in this case is also determined by the ratio of passage cross sectional areas of the gas-liquid mixture injection hole 12 provided in the gas-liquid injection nozzle 130 and the carrier gas passage 102b.

The atomizing air 10a flows into the atomizing gas passage 7 through the nozzle passage 103. The atomizing air 10a flowing in the atomizing gas passage 7 is supplied (emerged) so as to uniformly surround the whole periphery of the beginning end portion of the fuel spray 6 along the front end surface 24a of the liquid injection nozzle 24, as shown in an arrow mark in FIG. 2 and then passes through the gas-liquid mixture injection hole 12 to be injected into the guide 131 in the downstream portion of the gas-liquid mixture injection nozzle 130.

The fuel spray 6 is efficiently supplied into the mixture generating chamber 140 without adhering onto the gas-liquid mixture injection hole 12 by the gas-liquid mixture injection nozzle 130 and the shape of the gas-liquid mixture injection hole 12 and by supplying the atomizing air 10a with an appropriate velocity and an appropriate flow rate so that the atomizing air 10a may uniformly surround the whole periphery of the beginning end portion of the fuel spray 6. Then, the atomizing air 10a and the fuel spray 6 supplied to the mixed gas generating chamber 140 proceed to the orifice 17 through the guide 131. During that period, the atomizing air 10a promotes atomization and gas-liquid mixing of the fuel spray 6 by merging with the fuel spray 6.

The carrier air 10b is supplied from the carrier gas passage 102b to the carrier gas passage 8 of the annular gap, and then supplied from the rear end of the outer periphery of the guide 131 to the mixed gas generating chamber 140, and flows to the orifice 17 so as to surround the atomization promoted fuel spray 6 and the atomizing air 10a from the outer periphery.

The velocity of the fuel spray 6 and the atomizing air 10a and the carrier air 10b merged while being contracted by the orifice 17 is increased because the cross-sectional area of the orifice 17 becomes smaller as going toward downstream to improve the action of restricting and the ability of carrying the fuel spray 6. Therefore, the fuel spray 6, of which the atomization and the gas-liquid mixing are promoted by the atomizing air 10a, is carried by the carrier air 10b so as to be surrounded by the carrier air 10b from the whole periphery. Therefore, the amount of fuel adhered onto the wall surfaces in the various portions can be reduced, and can be supplied into the cylindrical heater 70.

There are large sized droplets in the fuel spray 6 of which the atomization and the mixing have been promoted. The large sized droplets are dropped down and adhered onto the wall surface of the intake pipe on the way without being transferred up to the combustion chamber 54 along the flow of the intake air (the atomizing air 10a and the carrier air 10b). In other words, the large sized droplets are short in the traveling distance. As a countermeasure of this problem, the large sized droplets are collided against the heater 70 or pass through the heater 70 to promote atomization and vaporization of the large sized droplets. By doing so, the amount of the fuel spray adhered onto the inner wall surface of the intake pipe is reduced.

The effect of the length L of the guide 131 of the gas-liquid mixture injection nozzle will be described below.

The fuel spray 6 injected from the liquid fuel injector 9 of the upstream swirl type forms a cone-shaped spray, and promotes the atomization as goes toward the downstream side. By making the length L of the guide 131 longer, the outlet portion of the carrier air 10b (the carrier gas passage 8) to the mixed gas generation chamber 140 can be brought closer to a portion of the downstream portion where the atomization of the fuel spray 6 is further promoted. Therefore, the carrier air 10b can be efficiently supplied into the mixed gas generation chamber 140 at a predetermined speed, and the carrying power to the fuel spray 6 can be increased, and the fuel spray 6 can be transported further downstream.

In addition, since the distance between the outlet portion of the carrier air 10b into the mixed gas generation chamber 140 is increased by shortening the length L of the guide 131, the supplying speed of the carrier air 10b supplied to the fuel spray 6 is decreased to decrease the carrying power to the fuel spray 6. However, since the flow of the carrier air 10b approaches to the gas-liquid mixture injection hole 12, the effect of dragging the atomizing air 10a and the fuel spray 6 passed through the gas-liquid mixture injection hole 12 becomes large. Because the dragging effect acts so as to increase the amount of the atomizing air 10a and to expand the liquid film portion of the fuel spray 6 just after injected from the liquid fuel injector 9, the atomization of the fuel spray 6 is further effectively promoted.

From the viewpoint of promoting the atomization of the fuel spray 6, it is better that the length L of the guide 131 is short, and it is preferable that the length L is zero.

Therefore, since the traveling position of the fuel spray 6 to the heater 70 can be easily changed by setting the length L of the guide 131 depending on the purpose, it is easy to cope with various kinds of engines.

Electric current is fed through the heater 70 at starting operation of the internal combustion engine 1, and the feeding of electric current is stopped at elapsing a preset time after the starting of operation. By doing so, useless feeding of electric current to the heater 70 is eliminated to reduce the electric power consumption.

In this embodiment according to the present invention, since the atomization of the fuel spray 6 is promoted by colliding the atomizing air 10a against the fuel spray 6, heat transfer between the intake air and the fuel spray 6 is improved. Further, since the atomization of the fuel spray 6 has been promoted, most part of the fuel spray 6 can flow along the flow inside the intake pipe without colliding against the heater 70 to reach the combustion chamber 54. Therefore, the burden of the heater 70 is reduced, and the electric power consumption can be suppressed. That is, the electric current fed to the heater 70 can be reduced, and accordingly the reliability and the durability of the heater 70 and the related parts can be improved.

According to this embodiment according to the present invention, since the fuel spray 6 injected to the mixed gas generation chamber 140 is efficiently promoted in the atomization and in the gas-liquid mixing to be vaporized, the amount of the fuel spray 6 adhering onto the wall surfaces of the orifice 17 and the heater 70 can be reduced, and accordingly the fuel spray 6 can be efficiently supplied into the intake assembling pipe 3. Then, the fuel spray 6 supplied to the intake assembling pipe 3 passes through the inside of the intake assembling pipe 3, and is supplied into the downstream intake pipe as the intake air (the mixing gas) 10f to be supplied to each of the combustion chambers 54.

Since the fuel spray 6 promoted in atomization and vaporization is to the combustion chamber 54, the ignition timing, that is, the ignition timing of the ignition plug 53 can be retarded compared to the normal condition with keeping the stability of combustion. Thereby, a high-temperature exhaust gas 26, which does not act on expansion work, can be generated inside the exhaust gas manifold 48, and accordingly the ternary catalyst converter 51 can be warmed up and activated in a short time. The exhaust gas 26 arriving at the exhaust gas manifold 48 is purified by removing harmful substances such as HC etc. produced at burning using the activated ternary catalyst converter 51, and then discharged to the outside through the dissipative muffler (not shown).

The install position and the shape of the heater 70 are not limited to those shown in this embodiment according to the present invention, and a lattice-shaped heater may be disposed downstream of the fuel spray 6. In this case, it is possible not only to promote vaporization of the very large droplets existing in the fuel spray 6 but also to promote vaporization of the atomized fuel spray 6. A plate heater may be disposed on a wall surface at a traveling position of the fuel spray 6. Further, it is possible to promote atomizing, gas-liquid mixing and vaporizing of the fuel spray 6 by arranging heaters 71a, 71b in the intake bypass pipes 5a, 5b to heat the atomizing air 10a and the carrier air 10b passing through the intake bypass pipes 5a, 5b.

In this embodiment according to the present invention, in the case where the idling speed is controlled by controlling opening and closing the throttle valve 4, it is possible to construct the system so as to supply the intake air through the bypass pipes 5a, 5b in the normal condition without using the ISC valve 73.

By using the liquid fuel injector 9 of the upstream swirl type, the injected fuel itself is rotated to promote the atomization. Therefore, since work of promoting the atomization by the atomizing air 10a can be reduced, the amount of the atomizing air 10a can be reduced by an amount corresponding to the reduced work. On the other hand, the amount of the carrier air 10b can be increased by an amount corresponding to the reduced work to increase the carrying power to the fuel spray 6.

Further, in this embodiment according to the present invention, there is provided the fuel atomizing means (atomizer) inside the liquid fuel injector 9, and the atomizing air 10a is merged with the fuel spray 6 at the outside of the liquid fuel injector 9. That is, it can be said that the atomizing air 10a constructs an atomizer of an external mixing type. The outlet of the liquid fuel injection hole of the liquid fuel injector 9 corresponds to the outlet of the atomizer.

The fuel spray 6 injected from the atomizer of the external mixing type (the liquid fuel injector 9) is promoted in the atomization and the gas-liquid mixing under a condition not restricted by the surrounding passage walls, for example, the gas-liquid mixture injection hole 12, the inner peripheral surface 134 and the outer peripheral surface 135 of the guide 131, the inner wall surface 150 of the atomizer base member 102, the orifice 17 and the inner wall surface (the inner peripheral surface) of the heater 70. That is, the fuel spray 6 is promoted in the atomization and the gas-liquid mixing under a condition out of contact with the surrounding passage walls.

The atomizer of the external mixing type in this embodiment according to the present invention can be constructed by concentrically fitting the liquid fuel injector 9 and the injection valve holder 120 and the gas-liquid mixture injection nozzle 130 to the atomizer base member 102, which improves the productivity.

The liquid fuel injector 9, the atomizing gas passage 7, the gas-liquid mixture injection hole 12, the carrier gas passage 8, the inner peripheral surface 134 and the outer peripheral surface 135 of the guide 131, the inner wall surface 150 of the atomizer base member 102, the orifice 17 and the inner wall surface (the inner peripheral surface) of the heater 70 are arranged on a coaxial line.

As described above, the atomizing means of the liquid fuel injector 9 is materialized by providing a fuel passage adding velocity components in the axial direction (the direction of the center axis of the liquid fuel injector 9 or the direction of the injected spray) and the tangential direction to the injected fuel spray 6.

The position of the passage wall surface surrounding the fuel spray 6 downstream of the liquid fuel injection hole of the liquid fuel injector 9 and the spray angle of the fuel spray 6 are set so that a gap may be formed between the passage wall surface and the outer periphery of the fuel spray 6. The passage wall surface is, for example, the downstream side portion of the gas-liquid mixture injection hole 12 in the gas-liquid mixture injection nozzle 130, the inner peripheral surface 134 inside the guide 131, the inner wall surface 159 of the atomizer base member 102, the inner wall surface of the orifice 17, the inner wall surface of the heater 70 or the like.

From another viewpoint, the cross section (diameter) of the passage of the fuel spray 6 in the range from the outlet (the downstream end) of the atomizing gas passage 7 to the outlet (the downstream end) of the carrier gas passage 8 is formed larger than the cross section (diameter) of the passage of the fuel spray 6 in the annular outlet opening portion of the atomizing gas passage 7. Otherwise, the cross section (diameter) of the passage of the fuel spray 6 in the range from the outlet (the downstream end) of the atomizing gas passage 7 to the outlet (the downstream end) of the carrier gas passage 8 is formed so as to be enlarged toward the downstream side.

This condition may be considered as a condition that an air layer is formed outside the outer edge of the fuel spray 6. This air layer is a layer having a very thin spray density compared to the spray density of the inside of the edge which is regarded as the outer edge of the fuel spray 6. By the effects of the atomizing air 1a and the carrier air 10b, the spray angle of the fuel spray 6 may sometimes become totally or partially smaller than the spray angle when the liquid fuel injector 9 is singly tested. Therefore, when the spray angle and the hole and each of the inner wall surfaces described above are set, it should taken the effects of the atomizing air 10a and the carrier air 10b into consideration.

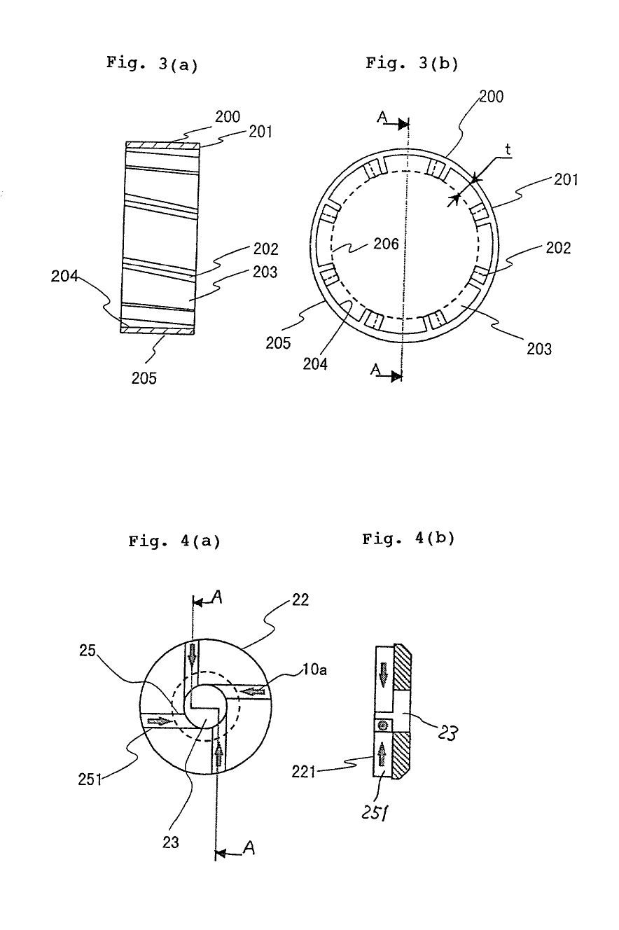

In this embodiment according to the present invention, a carrier gas swirl member 200 for imparting swirl to the carrier air 10b is arranged in the carrier gas passage 8, as shown in FIG. 2. The carrier gas swirl member 200 is composed of a cylinder portion 201 formed in a cylinder shape; and a plurality of fins 202 formed in a one piece together with the cylinder portion 201. The fin 202 is formed so as to have a height t toward the inner side from the inner peripheral surface of the cylinder portion 201, and formed in a helical shape in the axial direction along the inner peripheral surface of the cylinder portion 201, as shown in FIG. 3.

Referring to FIG. 3, the outer wall surface 135 of the guide 131 of the gas-liquid mixture injection nozzle 130 is in contact with the portion shown by a broken line 206 to form the axially helical carrier gas passage 203 by the outer wall surface 135 of the guide 131 and the fins 202 and the inner peripheral surface 204 of the cylinder portion 201. The carrier gas swirl member 200 is fixed by setting the outer peripheral surface 205 in contact with the inner wall surface 150 of the atomizer base member 102. Number of the fins 202 may be only one if the swirl force can be sufficiently imparted to the carrier air 10b.

The carrier air 10b flowing into the carrier gas passage 203 is imparted with a swirl force by passing through the inside of the carrier gas passage 203. The carrier air 10b is rotated to form a swirl. Since the fuel spray 6 is carried while being restricted by the carrier air 10b supplied with swirling in the mixed gas generating chamber 140 along the inner wall surface of the atomizer base member 102, the fuel spray 6 can be concentrated to the axial center portion (the central portion) of the passage to reduce the amount of fuel adhering onto the orifice 17 and the inner wall surface of the intake pipe.

In this embodiment, an atomizing gas swirl member 22 for imparting swirl to the atomizing air 10a is arranged in the atomizing gas passage 7, as shown in FIG. 2. The atomizing gas swirl member 22 is disposed on the surface of the atomizing gas passage 7 opposite to the front end surface 24a of the liquid fuel injection nozzle 24 of the liquid fuel injector 9. The front end surface 24a is in contact with the end surface 221 of the atomizing gas swirl member 22. A cylindrical hole 23 for letting the fuel spray 6 and the atomizing air 10a pass through is formed through the center of the atomizing gas swirl member 22.

Further, a plurality of grooves 251 in which the atomizing air 10a flows from the outer peripheral portion of the atomizing gas swirl member 22 toward the hole 23 are formed in the surface 221 of the atomizing gas swirl member 22. The direction of each of these grooves 251 is formed so as to be directed in a direction eccentric from the central axis of the hole 23. Four grooves 251 are formed in this embodiment according to the present invention. Swirl passages 25 are formed by contacting the front end face 24a of the liquid injection nozzle 24 of the liquid fuel injector 9 to a part of portion near the hole 23 of the grooves 251 so that the swirling atomizing air 1a may be supplied to the hole 23. The broken line shown in FIG. 4 (a) indicates the positional relationship of contact between the atomizing gas swirl member 22 and the front end surface 24a of the liquid injection nozzle 24 of the fuel injector 9.

The atomizing air 10a passes from the atomizing gas passage 7 through the swirl passages 25 formed by the grooves 251 of the atomizing gas swirl member 22. Since the atomizing air 10a collides with (merges with) the fuel spray 6 so as to eccentrically impart swirl to the fuel spray 6, it is possible to increase promoting the atomization and the gas-liquid mixing of the fuel spray 6.

In the liquid fuel injector 9 of the upstream swirl type injecting fuel by imparting swirl the fuel, the fuel spray 6 itself is injected so as to swirl. In order to increase promoting of the atomization and the gas-liquid mixing of the swirling fuel spray 6 as described above, it is better that the atomizing air 10a is collided with the fuel spray 6 while the atomizing air 10a is swirling in a direction opposite to a swirl direction of the fuel spray 6 by constructing the swirl passage 25 of the atomizing gas swirl member 22 so as to inject the atomizing air 10a swirling in the direction opposite to the swirl direction of the fuel spray 6.

The carrier air 10b may be blown into the intake assembling pipe 3 from the position and the direction indicated by an arrow mark 10b′ or an arrow mark 10b″, as shown in FIG. 2. In order to introduce the carrier air 10b into the intake assembling pipe 3 as shown by the arrow 10b′, the intake bypass pipe 5b is connected to the side wall 3a of the intake assembling pipe 3 toward the intake pipe 5 from the direction across the passage wall surface of the intake pipe 5.

On the other hand, in order to introduce the carrier air 10b into the intake assembling pipe 3 as shown by the arrow 10b″, the intake bypass pipe 5b is connected to the surface 3b of the intake assembling pipe 3 opposite to the fuel spray 6 in the injecting direction of the fuel spray 6. It is not always necessary that the carrier air 10b′, 10b″ is introduced perpendicularly to or parallel to the fuel spray 6 or the surface 3a, 3b of the intake assembling pipe 3. It is sufficient that the intake bypass pipe 5b is communicated with the intake assembling pipe 3 so as to merge with the fuel spray 6 with a predetermined angle taking the carrying efficiency of the fuel spray 6 into consideration.

By supplying the carrier air 10b′, 10b″ from the front of the fuel spray 6 so as to be opposite to the fuel spray 6, or from an opposite direction having an appropriate angle, the relative velocity of the collision between the fuel spray and the carrier air 10b′, 10b″ can be increased. Thereby, the carrier air 10b′, 10b″ can be actively used in promoting the atomization and the gas-liquid mixing of the fuel spray. Further, by supplying the carrier air 10b′, 10b″ to the intake assembling pipe 3, it is possible to reduce the amount of the fuel spray 6 adhering on the wall surface of the intake assembling pipe 3.

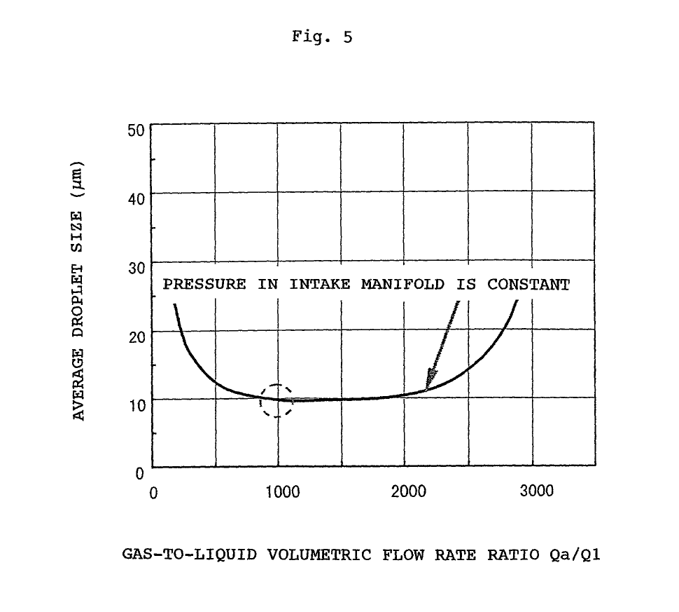

The relationship between the average droplet size of the fuel spray 6 to be supplied from the fuel supply device 100 to the internal combustion engine 1 and the amount of the atomizing air 10a will be described below, referring to FIG. 5.

The coordinate in the graph indicates the average droplet size of the fuel spray 6, and the average droplet size is a value at a position 60 mm downstream in the injection direction from the liquid injection hole of the fuel injector 9. The abscissa indicates the gas-to-liquid volumetric flow rate ratio (Qa/Ql), that is, the volumetric flow rate ratio (Qa) of the flow rate of the atomizing air 10a passing through the gas-liquid injection hole 12 to the flow rate (Ql) of the fuel spray injected from the fuel injector 9. The solid line in the graph indicates the relationship between the average droplet size and the gas-to-liquid volumetric flow rate ratio (Qa/Ql) under a pressure inside the intake pipe during idling operation of the internal combustion engine 1.

Therein, the amount of the atomizing air 10a is controlled by varying the area of the gas-liquid mixture injection hole 12 through which the atomizing air 10a passes under a constant pressure in the intake pipe. Further, the solid line in the graph was obtained by keeping the flow rate of fuel spray injected from the fuel injector 9 constant and varying only the flow rate of the atomizing air 10a.

There can be observed characteristics that the average droplet size of the fuel spray 6 is decreased as the gas-to-liquid volumetric flow rate ratio is increased, that is, as the flow rate of the atomizing air 10a is increased, and then the average droplet size becomes about 10 μm within a flow rate ratio range (Qa/Ql=nearly 700 to 2000), and the average droplet size becomes larger when the flow rate ratio exceeds the range. The above-mentioned characteristics are caused by the velocities of and the flow rates of the fuel spray 6 and the atomizing air 10a passing through the gas-liquid injection hole 12, and in addition by the positional relationship supplying the fuel spray 6 and the atomizing air 10a.

From the result, this embodiment according to the present invention employs the range of the gas-to-liquid volumetric flow rate ratio of 1000 circled by the broken line where the average droplet size is the smallest and the gas-to-liquid volumetric flow rate ratio is as small as possible. By doing so, the flow rate of the atomizing air 10a can be reduced while the average droplet size of the fuel spray 6 is being kept to a value near 10 μm. Therefore, since the carrier air 10b passing through the carrier gas passage 8 can be increased more, the carrying power to the fuel spray 6 can be improved, and accordingly the amount of fuel adhering onto the wall surface of the intake pipe can be reduced.

According to description of SAE99010792 “An Internally Heated Tip Injector to Reduce HC Emissions During Cold-Start”, a fuel spray can be transported to a combustion chamber by being carried on a gas flow in an intake pipe when an average droplet size is nearly 20 μm. In this embodiment according to the present invention, the average droplet size is below nearly 20 μm even if the flow rate ratio Qa/Ql is within a range of 250 to 2750, and 30 to 40% of the amount of the fuel spray having droplet size below 20 μm in the fuel spray can be transported to the combustion chamber.

Therefore, the amount of fuel adhering onto the wall surface of the intake pipe can be sufficiently reduced. The fuel spray not carried on the gas flow in the intake pipe passes through the inside of the heater 70 or collides with the heater 70 to be further promoted in atomization and vaporization. Thereby, the amount of fuel adhering onto the wall surface of the intake pipe can be reduced.

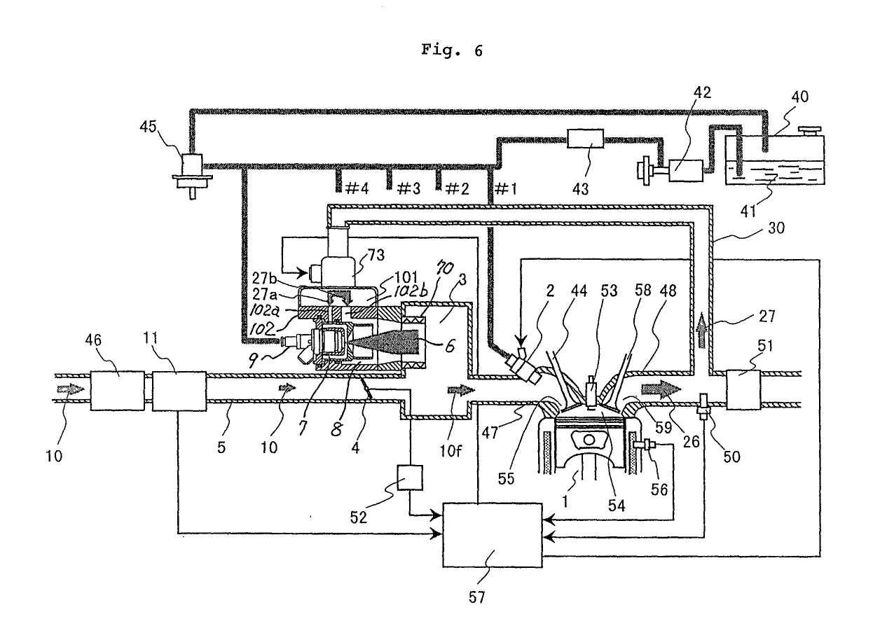

A second embodiment of the present invention will be described below, referring to FIG. 6. The second embodiment uses exhaust gas recirculation (EGR) gas as an atomizing gas for promoting atomization of the fuel spray and also as a carrier gas for carrying the atomized fuel spray.

In the second embodiment, EGR gas 27 of part of exhaust gas 26 exhausted from the internal combustion engine 1 is supplied to the atomizing gas passage 7 and the carrier gas passage 8 through an exhaust gas bypass pipe 30 as atomizing EGR gas 27a and carrying EGR gas 27b. Therefore, an inlet side (an upstream side end portion) of the exhaust gas bypass pipe 30 is communicated with the exhaust gas manifold 48, and an outlet side (a downstream side end portion) of the exhaust gas bypass pipe 30 is communicated with the atomizing gas passage 7 and the carrier gas passage 8 through the ISC valve 73 and the pressure regulation chamber 101.

The gas flow will be described below. The EGR gas 27 to be supplied to an atomizing gas passage 102a and a carrier gas passage 102b of an atomizer base member 102 through the pressure regulation chamber 101 flows in a condition pressurized by an exhaust gas pressure. That is, the pressure in the intake manifold 47 side becomes a negative pressure due to operation of the internal combustion engine 1, and the pressure in the exhaust gas manifold 48 side becomes a positive pressure. Therefore, the pressurized EGR gas 27 is supplied to both of the gas passages 102a and 102b.

Since the constructions of the other parts such as the atomizing gas passage 7, the carrier gas passage 8 etc. are similar to those in the first embodiment, the same reference characters are attached to the other parts and the overlapped description will be omitted here.

The EGR gas 27 is high in temperature and in pressure compared to those of the intake air sucked from the outside because it is a gas just after being exhausted. The heat and the pressure of the EGR gas 27 effectively act to promote the atomization and vaporization of the fuel spray 6 injected from the second liquid fuel injector 9.

Although in this embodiment according to the present invention, control of the intake air 10 supplied to the internal combustion engine 1 is performed by controlling opening and closing of the throttle valve 4, the intake air 10 can be controlled by the construction that the upstream side and the downstream side of the throttle valve 4 are connected to each other using a bypass pipe, and an ISC valve is arranged in the bypass pipe.

Further, although the construction in this embodiment according to the present invention is that the EGR gas 27 is supplied to the atomizing gas passage 7 and the carrier gas passage 8, it is possible to employ the piping construction that the EGR gas 27 is supplied to the carrier gas passage 8 and part of the intake air 10 is supplied to the atomizing gas passage 7, or that the EGR gas 27 is supplied to the atomizing gas passage 7 and part of the intake air 10 is supplied to the carrier gas passage 8.

According to this embodiment according to the present invention, the atomization and the vaporization of the fuel spray 6 can be promoted using the high-temperature and high-pressure EGR gas 27, and accordingly the burden of the heater 70 can be further reduced.

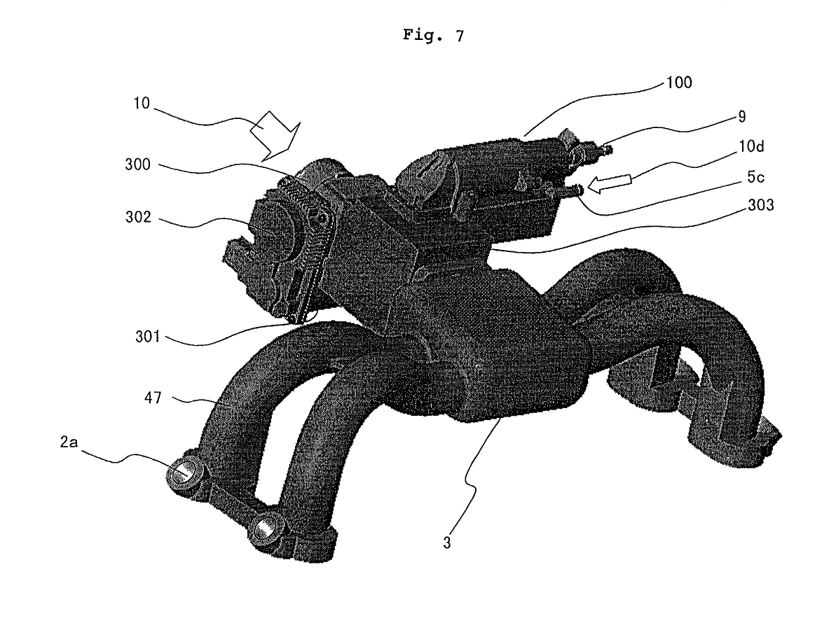

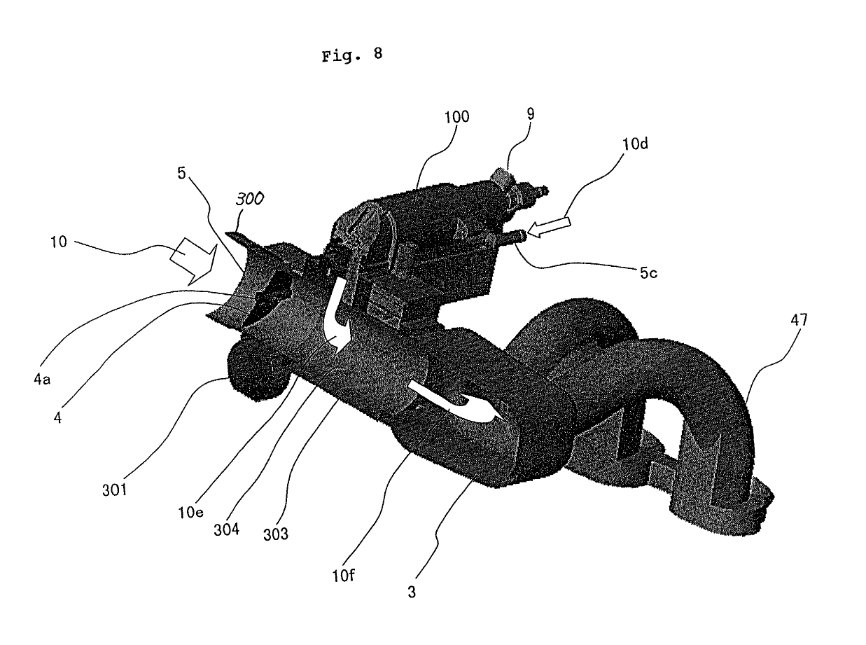

A third embodiment in accordance with the present invention will be described below, referring to FIG. 7 to FIG. 9.

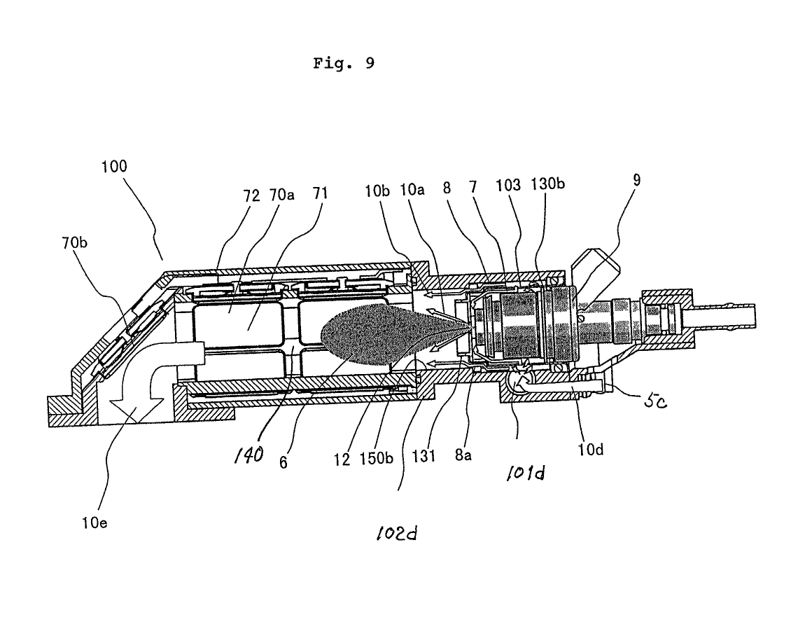

FIG. 7 is a perspective view showing the outer appearance of the fuel supply device 100 which has an intake passage portion and an intake passage portion 303 arranged between an electronic control throttle body 300 containing the throttle valve 4 and the intake assembling pipe 3 disposed in the upstream of the intake manifold 47. FIG. 8 is a cross-sectional view showing the electronic control throttle body 300, the intake passage portions 303, the intake assembling pipe 3 and the intake manifold 47 in FIG. 7 which is cut at nearly the center along the intake passage 5 and along the plane vertical to the throttle valve shaft 4a arranged inside the electronic control throttle valve body 300.

The intake manifold 47 has fuel injector mounting portions 2a for mounting the first liquid fuel injectors 2 each corresponding to the cylinders.

The intake passage 5 and the intake assembling pipe 3 inside the electronic control throttle valve 47 are communicated with each other by the intake passage 304 inside the intake passage portion 303. Further, the fuel supply device 100 is connected to and communicated with the intake passage 304 of the intake passage portion 303 so that the mixed gas 10e produced by the fuel spray injected from the second liquid fuel injector 9 disposed inside the fuel supply device 100 may be supplied to the intake passage 304 inside the intake passage portion 303. The mixed gas 10e supplied to the intake passage 304 flows into the intake assembling pipe 3 in the downstream side, and then passes through the intake manifold 47 to be efficiently supplied to each of the combustion chambers as the mixed gas 10f (the intake air and the fuel).

Although the structure in the third embodiment is that the spray direction of the fuel spray injected from the fuel injector 9 inside the fuel supply device 100 is nearly perpendicular to the axial flow direction of the intake passage 5 inside the electronic control throttle body 300, it is possible to employ the structure that the axial flow direction of the intake passage 5 is equal to the spray direction of the fuel spray injected from the fuel injector 9.

The electronic control throttle body 300 has the throttle valve 4 for controlling a desired amount of intake air corresponding to an operating condition of the internal combustion engine 1. That is, the amount of the intake air is controlled by opening degree of the throttle valve 4. Further, the electronic control throttle body 300 comprises a driving motor 301 for controlling the amount of the intake air by opening degree of the throttle valve 4; a drive mechanism for transmitting a power of the driving motor 301 in a throttle valve drive mechanism portion containing cover 302; and a throttle positioning sensor 52 for detecting the opening degree of the throttle valve 4.

The intake bypass pipe 5c of the fuel supply device 100 is communicated with the intake passage 5 upstream of the throttle valve 4 in the electronic control throttle valve 300 by the bypass passage (not shown) to supply a part of the intake air 10 to the intake bypass pipe 5c.

It is preferable that an air control valve for controlling air flow rate is provided in the bypass pipe communicating between the intake passage 5 upstream of the throttle valve 4 and the intake bypass pipe 5c in a case where the air flow rate is accurately controlled, or in a case where the control not supplying the air to the intake bypass pipe is performed.

FIG. 9 is a vertical cross-sectional view showing the atomizer portion in the fuel supply device 100 shown in FIG. 7 and FIG. 8 which is cut along the spray direction of the fuel spray 6 injected from the liquid fuel injector 9.

The intake bypass pipe 5c communicates with the pressure regulation chamber 101d formed inside the atomizer base member 102d. The pressure regulation chamber 101d communicates with the inner wall surface 150b of the atomizer base member 102d, and communicates with the carrier gas passage 8 of the annular gap formed between the part of the inner wall surface 150b and the outer wall surface of the gas-liquid mixture injection nozzle 130b. Further, the carrier gas passage 8 communicates with the mixed gas generating chamber 140 in the downstream portion of the atomizer base member 102d through a carrier gas measurement part 8a.

Further, at least one or more opening portions of nozzle passage 103 are bored in the side wall surface of the gas-liquid mixture injection nozzle 130b to communicate the inner and the outer wall surfaces of the gas-liquid mixture injection nozzle 130b with each other through the nozzle passage 103. Further, the atomizing gas passage 7 of the annular gap is formed by the inner wall surface of the gas-liquid mixture injection nozzle 130b and the outer peripheral portion of the liquid fuel injector 9 and the front end surface of the liquid fuel injection nozzle.

The atomizing gas passage 7 communicates with the gas-liquid mixture injection hole 12 arranged in the downstream side in the injection direction of the liquid fuel injector 9, and the gas-liquid mixture injection hole 12 opens to the mixture generating chamber 140 in the downstream side of the atomizer base portion 102c.

The downstream portion of the mixture generating chamber 140 communicates with the intake passage 304 in the intake passage portion 303 in the downstream side of the throttle valve 4.

In the heater portion 72 composing a part of the outer peripheral wall of the mixture generating chamber 140 arranged in the downstream side of the atomizer base member 102c of the fuel supply device 100, a plurality of plate-shaped heaters (PTC heaters) 70a are arranged in a cylindrical shape along the inner wall surface so as to surrounding the outer edge of the fuel spray 6. Further, a plate-shaped heater 70b is arranged with a predetermined angle to the spray axis direction of the fuel spray 6 in the downstream portion of the mixed gas generating chamber 140. The mixed gas 10e is formed by efficiently vaporizing the fuel spray 6 using these heaters so as to be guided into the intake passage 304 downstream of the throttle valve 4.

The fuel supply device 100 as described above makes the intake air 10d diverted from the intake air 10 upstream of the throttle valve 4 flow into the intake bypass pipe 5c through the bypass pipe (not shown) and then flows into the pressure regulation chamber 101d. After that, a part of the intake air 10d introduced into the pressure regulation chamber 101d is guided as the carrier air 10b to the carrier air passage 8 constructed by a part of the inner wall surface 150b of the atomizer base member 102d and the outer wall surface of the gas-liquid mixture injection nozzle 130b to be supplied to the mixed gas generating chamber 140b so as to surround the fuel spray 6 injected from the liquid fuel injector 9.

On the other hand, the remainder of the intake air 10d flowing into the pressure regulation chamber 101d is guided as the atomizing air 10a into the atomizing gas passage 8 formed by the inner wall surface of the gas-liquid mixture injection nozzle 130b and the outer peripheral portion and the front end surface of the liquid fuel injector 9, and efficiently supplied (collided) from nearly the whole periphery to the beginning end portion of the fuel spray 6 injected from the liquid fuel injector 9, and then made to pass through the gas-liquid mixture injection hole 12 to be supplied into the mixed gas generating chamber 140 disposed in the downstream side of the gas-liquid mixture injection hole 12.

By the structure and the atomizing air 10a and the carrier air 10b, the fuel spray 6 injected from the fuel injector 9 is efficiently promoted in atomization, and efficiently transported. Further, since the heaters 70a are cylindrically arranged along the outer periphery of the fuel spray 6, the large sized droplets in the outer side of the fuel spray 6 are efficiently promoted in atomization and vaporization when the fuel spray 6 passes through the mixed gas generating chamber 140, and the droplets including large droplets difficult in atomization and transportation by the atomizing air 10a and the carrier air 10b can be promoted in vaporization by being collided with the heaters 70a.

Further, the heater 70b arranged in a predetermined angle in the injection direction of the fuel spray 6 injected from the fuel injector 9 can change the traveling direction of the fuel spray 6, and the mixed gas 10e produced from the fuel spray 6 can be efficiently supplied into the intake passage 304 in the downstream side of the throttle valve 4. Thus, the fuel spray 6 can be efficiently transported to the intake manifold 47 through the inside of the intake assembling pipe 3 downstream of the intake passage 304 and further to each of the combustion chambers (not shown in the figure).

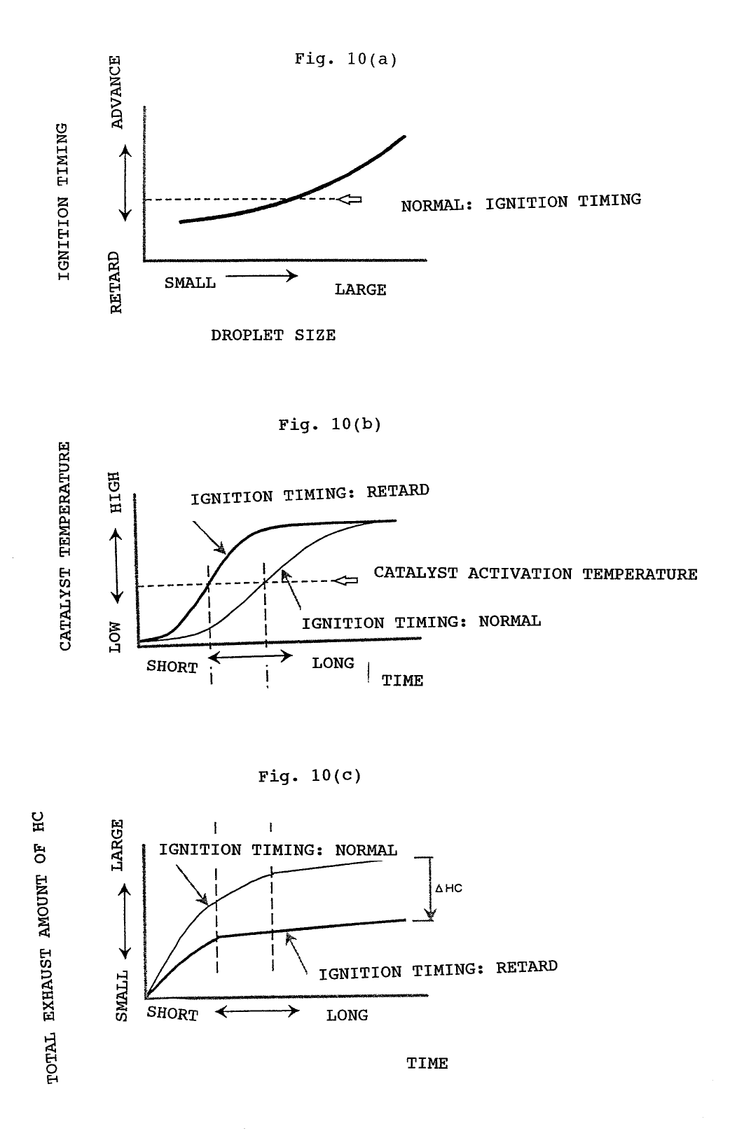

The effects common in the above-described embodiments will be described below, referring to FIG. 10(a), FIG. 10(b) and FIG. 10(c).

In FIG. 10(a), the coordinate indicates ignition timing and the abscissa indicates droplet size of the fuel spray supplied from the fuel supply device 100. In FIG. 10(b), the coordinate indicates catalyst temperature and the abscissa indicates time, and the thin line shows the relationship between catalyst temperature and time when the ignition timing of the internal combustion engine is normal, and the bold line shows the relationship between catalyst temperature and time when the ignition timing of the internal combustion engine is retard. In FIG. 10(c), the coordinate indicates total amount of exhausted HC and the abscissa indicates time, and the thin line shows the relationship between total amount of exhausted HC and time when the ignition timing of the internal combustion engine is normal, and the bold line shows the relationship between total amount of exhausted HC and time when the ignition timing of the internal combustion engine is retard.

The intake air 10a or the EGR gas 27 is controlled by controlling the ISC valve 73 at cold start or normal-temperature start, and part of the atomizing air 10a or the atomizing EGR gas 27a is collided with the fuel spray 6 from the whole periphery so as to be opposite to each other. Thereby, the atomization and the gas-liquid mixing of the fuel spray 6 are promoted. Then, in order to suppress the fuel spray 6 from adhering onto the inner wall surface of the intake pipe, the flow of the carrier gas 6 or the carrier EGR gas 27b for carrying the fuel spray 6 is formed and further the heaters 70 are arranged in the downstream portion. Thereby, the atomization and the mixing vaporization and the vaporization can be promoted to reduce the amount of the fuel spray adhering onto the wall surface.

The reason is as follows. The vaporization of the fuel spray 6 can be accelerated by atomization of the fuel spray 6 to increase a surface area per unit fuel mass, and the property of the fuel spray 6 following to the air flow inside the intake manifold 47 is improved, and the flow for carrying the atomized fuel spray 6 is formed. Therefore, the amount of the fuel adhering onto the inner wall surface can be reduced. Further, by reducing the amount of fuel adhering onto the wall surface, the starting performance and the fuel economy of the internal combustion engine 1 can be improved, and in addition the exhaust gas cleaning performance can be also improved.

Further, by promoting the atomization, the gas-liquid mixing and the vaporization of the fuel spray 6 to be supplied to the internal combustion engine 1, the ignition timing of the internal combustion engine 1 can be retarded with keeping the stability of combustion, as shown in FIG. 10(a).

By retarding the ignition timing compared to the normal condition, high-temperature exhaust gas not performing expansion work can be produced, and catalyst temperature of the ternary catalyst converter 51 can be increased up to a high temperature in a short time using the high-temperature exhaust gas, as shown in FIG. 10(b). In the graph, the horizontal dotted line indicates the catalyst activation temperature, and the catalyst temperature can be increased up to the catalyst activation temperature in a short time by heating the catalyst using the high temperature exhaust gas.

By activating the catalyst of the ternary catalyst converter 51 in a short time, the total amount of exhausted HC can be substantially reduced at starting operation of the internal combustion engine 1 compared to in the case of normal ignition timing, as shown in the graph of FIG. 10(c). Further, by warming-up of the ternary catalyst converter in a short time, the amount of exhausted NOx and CO, in addition to HC, can be also reduced.

As described above, by promoting the atomization and the gas-liquid mixing and the vaporization of the fuel spray 6 injected from the fuel injector 9, the amount of fuel adhering onto the inner wall surface of the intake pipe can be reduced, and cold start and normal-temperature performance of the internal combustion engine can be improved, and the fuel economy can be improved, and further the exhaust gas cleaning performance can be improved.

Although the construction using the heater 70 is described in the embodiments described above, the present invention can be applied to a construction eliminating the heater 70 if the atomization, the gas-liquid mixing and the vaporization by the atomizing gas and the carrier gas are sufficiently performed.

Although each of the embodiments described above according to the present invention is explained by taking what is called the port injection engine which has the first fuel injector 2 for injecting fuel to each of the cylinders in the intake manifold 47, the same effects can be attained by applying the present invention to what is called the in-cylinder injection type internal combustion engine (the direct fuel injection type internal combustion engine) in which fuel is directly injected into the combustion chamber.

According to the present invention, since the amount of fuel adhering onto the wall surface can be reduced by promoting the atomization and the gas-liquid mixing of the fuel spray injected from the liquid fuel injector, the starting performance and the fuel consumption of the internal combustion engine can be improved, and the exhaust gas purification can be also improved. In addition, since the heater is used as an auxiliary, the burden of the heater is reduced, and the electric energy consumed by the heater can be made small or the heater can be eliminated in some cases. Further, by reducing the electric energy consumed by the heater, the reliability and the durability of the heater can be improved.

What is claimed is:

1. A fuel supply device comprising a fuel atomizing device for atomizing fuel spray injected from a liquid fuel injector by an action of gas, said atomized fuel spray being supplied in a downstream of a throttle valve in an intake pipe having said throttle valve, wherein
the fuel supply device comprises:
a first gas passage for jetting atomizing gas which acts on said fuel spray injected from a liquid fuel injection hole of said fuel injector to promote atomization of said fuel spray, said first gas passage being opened around said liquid fuel injection hole;
a second gas passage for generating a mixed gas by jetting a carrying gas to said fuel spray so as to surround around said fuel spray of which atomization is promoted by said atomizing gas; and
a heater disposed so as to be positioned in the periphery of a carrying passage of said mixed gas.

2. A fuel supply device according to claim 1, wherein
an average droplet size of said fuel spray is smaller than 20 μm.

3. A fuel supply device according to claim 1, wherein
said fuel atomizing device sets a ratio Qa/Ql of an amount of atomized gas Qa to an amount of injected fuel Ql to a value in a range of 250 to 2750.

4. A fuel supply device according to any one of claim 1 to claim 3, wherein
said liquid fuel injector in said fuel atomizing device comprises a fuel passage which imparts velocity components in an axial direction and in a tangential direction to said injected fuel.

5. A fuel supply device according to claim 4, wherein
said first gas passage is formed so as to have a front end surface of said fuel injector as a part of a wall of said first gas passage.

6. A fuel supply device according to any one of claim 1 to claim 5, wherein
said first gas passage is a gas passage which annular opens around a central axis passing through a center of said liquid fuel injection hole of said fuel injector and being virtually directed in a direction of injecting said fuel spray, and lets said gas flow toward said liquid fuel injection hole in a direction across said central axis, and
said second gas passage is a gas passage which has an annular opening directed toward said direction of injecting said fuel spray around said central axis.

7. A fuel supply device according to any one of claim 1 to claim 6, wherein
a flow rate of the carrying gas flowing through said second gas passage is larger than a flow rate of said atomized gas flowing through said first gas passage.

8. A fuel supply device according to any one of claim 1 to claim 7, wherein
said first gas passage and said second gas passage are formed in that end portions of said gas passages in the upstream side are commonly constructed as one gas passage branched from an intake pipe in said upstream side of said throttle valve, and said one gas passage is branched into two passages in said downstream side.

9. A fuel supply device according to any one of claim 1 to claim 7, wherein
at least one upstream side end portion of the gas passage between said first gas passage and said second gas passage is connected to an exhaust pipe of an internal combustion engine.

10. An internal combustion engine comprising a fuel supply device according to any one of claim 1 to claim 9.
